(19) United States
(12) Patent Application Publication
(10) Pub. No.: US 2006/0099837 A1
(43) Pub. Date: May 11, 2006

(54) Metal mobile phone case

(76) Inventors: Yung-Fa Cheng, Taipei Shien (TW); Hsiang-Lung Kao, Taipei City (TW)

Correspondence Address: RABIN & BERDO, P.C., Suite 500, 1101 14 Street, N.W., Washington, WA, 20005, US

(21) Appl. No.: 11/184,974

(22) Filed: Jul. 20, 2005

(30) Foreign Application Priority Data
Nov. 11, 2004 (TW) 93134529

(51) Int. Cl. H01R 13/44

(52) U.S. Cl. 439/131

(57) ABSTRACT

The present invention relates to a metal mobile phone case. The metal mobile phone case has an upper housing and a lower housing. Sliding-slots are on two sides of the upper housing. Sliding-blocks corresponding to the sliding-slots are on two sides of the lower housing. By inserting the sliding-blocks into the sliding-slots, the upper housing and the lower housing are assembled. The lower housing further has an antenna cavity and a battery cavity. By placing an antenna cover and a battery cover on the antenna cavity and the battery cavity respectively, the upper housing and the lower housing can further be secured.

### RELATED APPLICATIONS

The present application is based on, and claims priority from, Taiwan Application Serial Number 93134529, filed Nov. 11, 2004, the disclosure of which is hereby incorporated by reference herein in its entirety.

### BACKGROUND

1. Field of Invention

The present invention relates to a mobile phone case. More particularly, the present invention relates to a metal mobile phone case.

2. Description of Related Art

Currently, most mobile phone cases are made of plastic materials. A plastic mobile phone case insufficiently hard and is vulnerable to cracking in collisions. The lifespan of the plastic mobile phone case is also unsatisfactory. Besides, the plastic mobile phone case is usually made by injection molding, which often creates defects during the manufacture. On the contrary, the mobile phone case made of metal has superior hardness and duration, as well as a better yield during manufacturing.

Currently, most metal mobile phone cases are made by a manufacturing technique known as deep drawing. In deep drawing, several molds are required for step-by-step pressing a metal plate into a desired shape. However, the shapes that can be formed by deep drawing are limited. Usually, shapes with sharp edges are not possible. In deep drawing, the metal plate is extended and thinned. Therefore, the edges are vulnerable to tensile stress and will fracture easily.

Furthermore, a conventional mobile phone case is composed of an upper portion and a lower portion. The upper portion and the lower portion are assembled by clasps vertically projecting out of the upper portion and the lower portion. However, as described above, sharp edges can't be achieved by deep drawing, and additional processing is required to attach the clasps to the upper portion and the lower portion. This additional processing dramatically increases the manufacturing complexity and cost.

### SUMMARY

It is therefore an objective of the present invention to provide a metal mobile phone case with a sliding mechanism for assembly. It is therefore another objective of the present invention to provide a metal mobile phone case assembled by a connecting component.

In accordance with the foregoing and other objectives of the present invention, a metal mobile phone case, including an upper housing and a lower housing, is proposed. Sliding-slots are on two sides of the upper housing, and sliding-blocks corresponding to the sliding-slots are on two sides of the lower housing. By inserting the sliding-blocks into the sliding-slots, the upper housing and the lower housing are assembled. The cavity between the upper housing and the lower housing accommodates the mobile phone circuitry.

In accordance with another objective of the present invention, a metal mobile phone case, including an upper housing, a lower housing, and a connecting component, is proposed. Upper sliding-slots are on two sides of the upper housing, while lower sliding-slots are on two sides of the lower housing. The connecting component includes upper sliding-blocks corresponding to the upper sliding-slots, and lower sliding-blocks corresponding to the lower sliding-slots. By inserting the upper sliding-blocks and the lower sliding-blocks into the upper sliding-slots and the lower sliding-slots, respectively, the upper housing and the lower housing are assembled. The cavity between the upper housing and the lower housing accommodates the mobile phone circuitry.

The metal mobile phone case according to the present invention utilizes a sliding mechanism to simplify the assembly procedure and increase the manufacturing efficiency. Moreover, the metal mobile phone case according to the present invention can be made by extrusion. Extrusion requires fewer molds during the manufacturing procedures. Accordingly, the cost for the molds can be reduced, and the lifetime of the molds can be extended. Further, by extrusion, shapes with sharp edges can be achieved, which can provide more flexibility during manufacture.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings, where:

FIG. 1 is a perspective diagram illustrating the metal mobile phone case according to the first preferred embodiment of the present invention;

FIG. 2 is an assembly diagram illustrating the metal mobile phone case according to the first preferred embodiment of this invention;

FIG. 3 is another assembly diagram illustrating the metal mobile phone case according to the first preferred embodiment of the present invention;

FIG. 4 is a cross-sectional diagram illustrating the metal mobile phone case according to the second preferred embodiment of the present invention;

FIG. 5 is a cross-sectional diagram illustrating the metal mobile phone case according to the third preferred embodiment of the present invention; and

FIG. 6 is a diagram illustrating the metal mobile phone case according to the present invention after assembled.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The metal mobile phone case according to the present invention is composed of an upper housing and a lower housing. Corresponding sliding-slots and sling-blocks are on two sides of the upper housing and the lower housing, respectively. The upper housing and the lower housing can be assembled more securely by the sliding-slots and the sliding-blocks set. Further, the metal mobile phone case according to the present invention is made by extrusion. Extrusion requires fewer molds during the manufacturing procedures. In extrusion, shapes with sharp edges can also be achieved, which can provide more flexibility during manufacture.

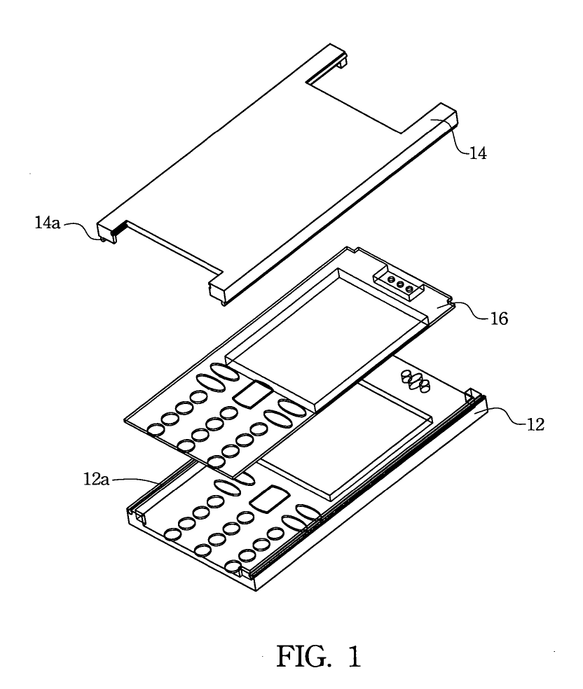

FIGS. 1-3 illustrate a metal mobile phone case according to the first preferred embodiment of the present invention. As shown in the FIG. 1, the metal mobile phone case according to the present invention includes a first housing 12 and a second housing 14. Sliding-slots 12a are on two sides of the first housing 12, while sliding-blocks 14a corresponding to the sliding-slots 12a are on two sides of the second housing 14. The first housing 12 and the second housing 14 are assembled by inserting the sliding-blocks 14a into the sliding-slots 12a. The cavity between the first housing 12 and the second housing 14 can accommodate the mobile phone circuitry 16.

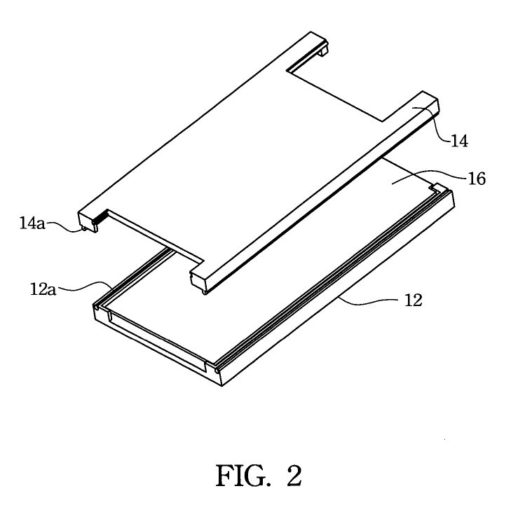

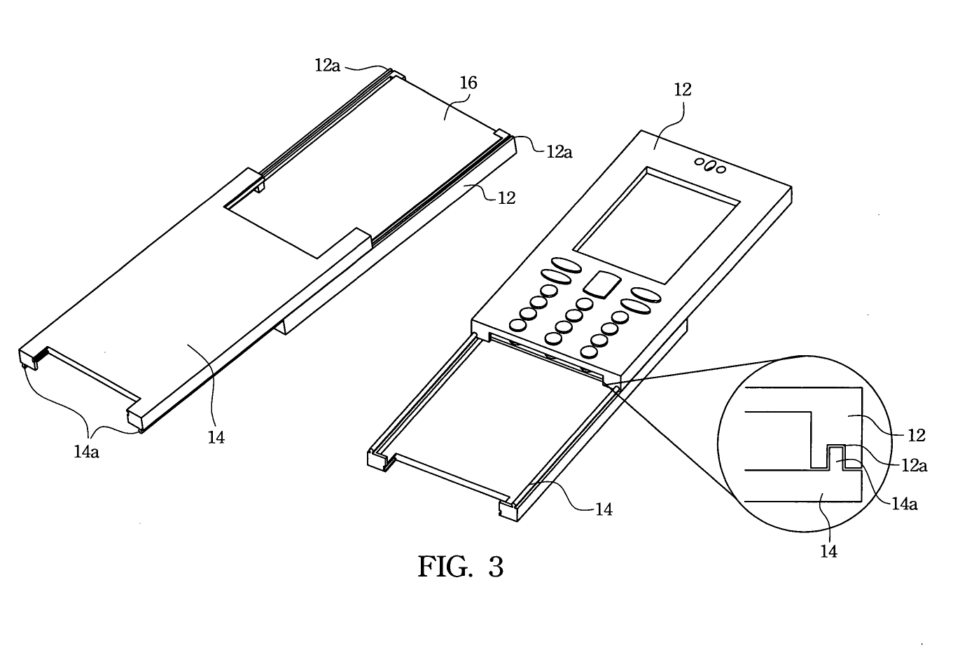

FIG. 2 and FIG. 3 are assembly diagrams further demonstrating the assembly process of the metal mobile phone case according to the first embodiment of the present invention. As shown in the FIG. 2, during the assembly, the mobile phone circuitry 16 is first placed into the first housing 12. Next, the sliding-blocks 14a are inserted into the sliding-slots 12a and slid therein. As a result, the first housing 12 and the second housing 14 are assembled. As can be seen from FIG. 3, the configuration of the sliding-slots 12a can be concave, while the configuration of the sliding-blocks 14a can be convex.

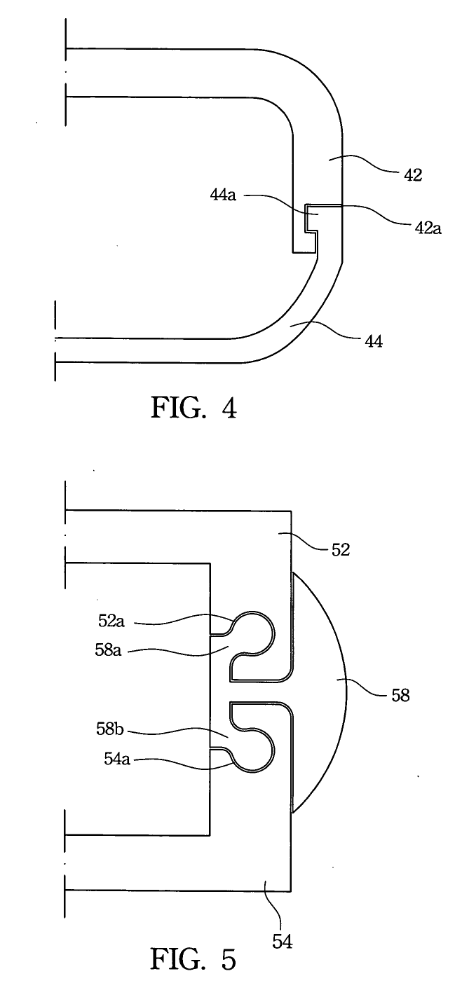

FIG. 4 is a cross-sectional diagram illustrating the metal mobile phone case according to the second preferred embodiment of the present invention. Except for the concave-convex pair configuration of the sliding-slots and sliding-blocks in the first preferred embodiment, the configuration of the sliding-slots 42a can be L-shaped, while the configuration of the sliding-blocks 44a can be a corresponding reversed L-shape. The first housing 42 and the second housing 44 can also be assembled in this alternative configuration.

Further, a connecting component can be employed for assembling the first housing and the second housing. FIG. 5 is a cross-sectional diagram illustrating the metal mobile phone case according to the third preferred embodiment of the present invention. The connecting component 58 is employed in assembling the first housing 52 and the second housing 54. The first sliding-slots 52a with Ω shape are on two sides of the first housing 52, while the second sliding-slots 54a with Ω shape are on two sides of the second housing 54. The first sliding-blocks 58a corresponding to the first sliding-slots 52a and the second sliding-blocks 58b corresponding to the second sliding-slots 54a with reversed Ω shape are on the connecting component 58. By inserting the first sliding-blocks 58a into the first sliding-slots 52a, and the second sliding-blocks 58b into the second sliding-slots 54a, the first housing 52 and the second housing 54 are assembled. The connecting component 58 can be made of rubber and function as a protective cushion at the same time.

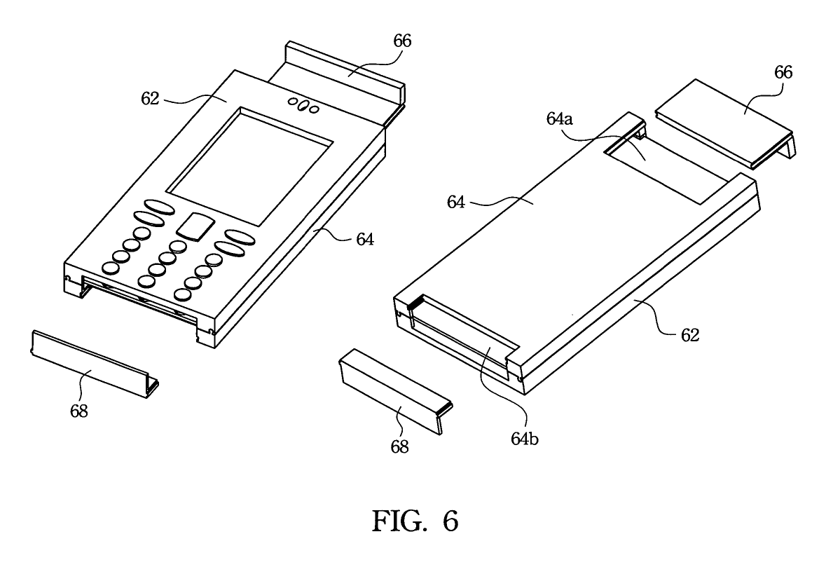

Referring to FIG. 6, the second housing 64 further includes an antenna cavity 64a and a battery cavity 64b. After the first housing 62 and the second housing 64 are assembled by the sliding-slots and the sliding-blocks, the antenna cover 66 can further be placed on the antenna cavity 64a, while the battery cover 68 can be placed on the battery cavity 64b. The antenna cover 66 and the battery cover 68 can further secure the first housing 62 and the second housing 64.

The first housing and the second housing can be made by extrusion. That is, after heating a metal plate to the melting temperature, the metal plate is pressed through the mold to form the desired first housing and the second housing. Extrusion has the advantages of high productivity, excellent yields, flexible shapes, and lower cost. Besides, unlike the deep drawing technique, there is only one mold required in extrusion, and the cost for the molds can also be reduced.

The metal mobile phone case according to the present invention utilizes a sliding mechanism to simplify the assembling procedure and increase the manufacturing efficiency thereof. Moreover, the metal mobile phone case according to the present invention can be made by extrusion. Extrusion requires fewer molds during the manufacturing procedures. Accordingly, the cost for the molds can be reduced, and the lifetime of the molds can be extended. Further, in extrusion, shapes with sharp edges can be achieved, which can provide more flexibility during manufacturing.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A metal mobile phone case, the metal mobile phone case comprising:
a first housing having sliding-slots on sides of the first housing; and
a second housing having sliding-blocks on sides of the second housing, and corresponding to the sliding-slots;
whereby when the sliding-blocks are inserted into the sliding-slots, the first housing and the second housing are assembled, and a cavity between the first housing and the second housing accommodates a mobile phone circuitry.

2. The metal mobile phone case of claim 1, wherein a cross section of the sliding-block is convex.

3. The metal mobile phone case of claim 2, wherein a cross section of the sliding-slot is concave.

4. The metal mobile phone case of claim 1, wherein a cross section of the sliding-block is a reversed L-shape.

5. The metal mobile phone case of claim 4, wherein a cross section of the sliding-slot is L-shaped.

6. The metal mobile phone case of claim 1, wherein the second housing further includes an antenna cavity.

7. The metal mobile phone case of claim 6, wherein an antenna cover is placed on the antenna cavity for securing the first housing and the second housing.

8. The metal mobile phone case of claim 1, wherein the second housing further includes a battery cavity.

9. The metal mobile phone case of claim 8, wherein a battery cover is placed on the battery cavity for securing the first housing and the second housing.

10. The metal mobile phone case of claim 1, wherein the metal mobile phone case is made by extrusion.

11. A metal mobile phone case, the metal mobile phone case comprising:
a first housing having first sliding-slots on sides of the first housing;
a second housing having second sliding-slots on sides of the secodn housing; and
at least one connecting component having first sliding-blocks corresponding to the first sliding-slots, and second sliding-blocks corresponding to the second sliding-slots;
whereby when the first sliding-blocks are inserted into the first sliding-slots, and the second sliding-blocks are inserted into the second sliding-slots, the first housing and the second housing are assembled, and a cavity between the first housing and the second housing accommodates a mobile phone circuitry.

12. The metal mobile phone case of claim 11, wherein a cross section of the first sliding-block and the second sliding-block are Ω shaped.

13. The metal mobile phone case of claim 11, wherein a cross section of the first sliding-slot and the second sliding-slot are reversed Ω shaped.

14. The metal mobile phone case of claim 11, wherein the second housing further includes an antenna cavity.

15. The metal mobile phone case of claim 14, wherein an antenna cover is placed on the antenna cavity for securing the first housing and the second housing.

16. The metal mobile phone case of claim 11, wherein the second housing further includes a battery cavity.

17. The metal mobile phone case of claim 16, wherein a battery cover is placed on the battery cavity for securing the first housing and the second housing.

18. The metal mobile phone case of claim 11, wherein the metal mobile phone case is made by extrusion.

19. The metal mobile phone case of claim 11, wherein the connecting component is made of rubber.
